(19) United States
(12) Patent Application Publication
(10) Pub. No.: US 2023/0309597 A1
(43) Pub. Date: Oct. 5, 2023

(54) METHOD FOR MANUFACTURING FILLING BAG PRODUCT OF TREMELLA MIXED FORMULA RAW MATERIALS

(71) Applicant: Well Youth Biotech Co.,Ltd., Taichung City (TW)

(72) Inventors: Yu-Cheng LEE, Taichung City (TW); You-Chun SIE, Taichung City (TW)

(21) Appl. No.: 17/876,561

(22) Filed: Jul. 29, 2022

(30) Foreign Application Priority Data
Mar. 28, 2022 (TW) 111111726

(51) Int. Cl. B65B 55/14; A23L 31/15; A23L 5/10; B65B 55/06

(52) U.S. Cl. CPC A23L 31/15; A23L 5/15; B65B 55/06; B65B 55/14

(57) ABSTRACT

The present invention provides a method for manufacturing filling bag product of tremella mixed raw materials. Firstly, tremella raw material is put into a container of a drying system. Next, the tremella raw material is baked in the container of the drying system to dry the tremella. Then, the dried tremella raw material is placed into a grinder to grind it into tremella powder. Subsequently, the tremella powder is added with formula raw materials to evenly mix in a mixer to form tremella mixed liquid. Then, a filling machine is used to fill the tremella mixed liquid into a small package to form a tremella filling bag product.

### CROSS-REFERENCE STATEMENT

The present patent application is based on, and claims priority from, Taiwan patent Application Serial Number 111111726, filed Mar. 28, 2022, the disclosure of which is hereby incorporated by reference herein in its entirety.

### TECHNICAL FIELD

The present invention relates to a tremella product, more specifically, a method for manufacturing filling bag product of tremella mixed formula raw materials.

### BACKGROUND

Tremella (white fungus) is a higher basidiomycete, known as the king of fungi. Tremella belongs to fungi, dikarya, basidiomycota, agaricomycotina, tremellales, tremellaceae and tremella in scientific taxonomy. According to statistics, there are more than 40 species of tremella in the world, which are composed of two parts: the mycelium of vegetative organs and the fruiting body of reproductive organs. The fruiting body of fresh tremella is pure white and translucent; when dry, it is horny, hard and brittle, and white or beige.

Generally speaking, the edible part of tremella is fruiting body, which is rich in dietary fiber and protein 6.7% ~ 10%, carbohydrate 65% ~ 71.2%, fat 0.6% ~ 12.8%, crude fiber 2.4% ~ 2.75%, inorganic salt 4% ~ 5.4%, water 15.2% ~ 18.7% and a small amount of vitamin B group. Protein of tremella contains a variety of amino acids. The main component of tremella also contains anti-tumor polysaccharides (β -glucan), and therefore it has gradually become a high-value agricultural product.

Tremella can be obtained from two sources. One is to extract mycelium from liquid culture, and the other is edible fruiting body cultured in space bag. However, because the extraction technology is immature, it cannot be commercialized for mass production. The traditional method of extracting polysaccharides from fruiting body of tremella is to treat the fruiting body of tremella with alkaline chemicals, rinse or adjust the pH value to neutrality, and then extract with hot water or ethanol. Based on this extraction method, the extraction rate of tremella polysaccharide can reach 27 ~ 30%, but it is possible to make the obtained tremella polysaccharide with residual chemicals by means of chemical extraction.

In addition to the above residual chemicals of tremella polysaccharide, the process of cooking and refining of tremella in the cauldron on the market is not only unable to eat fresh tremella, but also has the problems of preservation, storage and transportation. Therefore, the invention does not adopt the extraction method or cooking and refining method by cauldron, but develops a novel method for manufacturing tremella product to solve and overcome the above problems.

### SUMMARY

The traditional cooking process of tremella destroys too many nutrients, the distribution channel is not only poor, but the transportation is also inconvenient. Therefore, the invention proposes a method for releasing a large amount of polysaccharides from tremella and retaining a variety of nutrients by using a low-temperature drying technology.

According to one aspect of the invention, a method for manufacturing filling bag product of tremella comprises the following steps. Firstly, a food-receiving container of a drying system is preheated to internal temperature of 40° C. ~ 45° C. by a heating device, followed by placing the tremella raw material into the food-receiving container. Next, the food-receiving container is heated to the internal temperature of temperature 60° C. ~ 70° C. to dry the tremella raw material by the heating device when a water content of the tremella raw material drops to a range measured by a hydro-thermograph. Then, the dried tremella raw material is grinded by a grinder to form tremella powder. Subsequently, the tremella powder is mixed with formula raw materials by a mixer to form a tremella mixture. In the following, the tremella mixture is filled in a package by a filling machine. A water content of the tremella raw material is less than 8% measured by the hydro-thermograph to stop drying the tremella raw material.

According to another aspect, after the tremella mixture is filled in a package, the tremella mixture in said package is ripened through a high temperature and high pressure process such that a large number of trace elements with tremella polysaccharide, minerals and calcium ions hidden in the deep layer are released from the thick cell wall to fuse a unique ionic flavor.

According to one aspect of the invention, the dried tremella raw material is grinded by a grinder to form dried tremella powder, wherein an operating temperature is less than 20° C. and a humidity is less than 60% controlled by a controller.

The above description is used to explain the purpose, technical means and the achievable effect of the invention. Those familiar with the technology in the relevant field can understand the invention more clearly through the following embodiments, the accompanying description of the drawings and claims.

### BRIEF DESCRIPTION OF THE DRAWINGS

The components, characteristics and advantages of the present invention may be understood by the detailed descriptions of the preferred embodiments outlined in the specification and the drawings attached:

FIG. 1 shows a function block of a drying system or device of tremella according to an embodiment of the present invention.

FIG. 2 shows a process flow of a method for manufacturing filling bag product of tremella mixed formula raw materials according to an embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The invention discloses a method for manufacturing a filling bag of tremella mixed formula raw materials. Through a low-temperature drying technology, the polysaccharide released from tremella is retained and locked, and the polysaccharide itself is not damaged, for facilitating to perfectly integrate tremella with other formulas in the subsequent process. Other formulas include lotus seeds, black fungus, red beans, mung beans, soybeans, black beans, cereals, job’s tears (Chinese pearl barley), traditional Chinese medicine (medicinal material), red dates (Chinese jujubes), medlars and cordyceps spp. The technical principle of low-temperature drying is used to remove water, so it can better preserve the taste and nutrition of tremella.

Cordyceps spp. may include cordyceps fungi, such as cordyceps militaris, cordyceps hawkesli, cordyceps liangshanensis, cordyceps ophioglossoides, cordyceps myrmecophila, cordyceps nutans.

The invention utilizes a grinding process such that the particle size of tremella particles after dried at low temperature can pass through the filling pipeline of a filling device (filling machine), and the tremella will be leavening back to fresh tremella again in case of water. It is suitable for making lightweight aluminum foil package for replenishing tremella nutrition at any time.

The invention relates to a manufacturing method of filling bag (aluminum foil package) of the above tremella mixed formula raw materials, which uses an appropriate heating device to process under predetermined processing conditions (such as baking or microwave treatment specific output power value, processing time, processing quantity, etc.). The heating device includes a microwave generator or a baking oven. The treatment mode of the heating device includes an intermittent heating (microwave) treatment or a continuous heating (microwave) treatment.

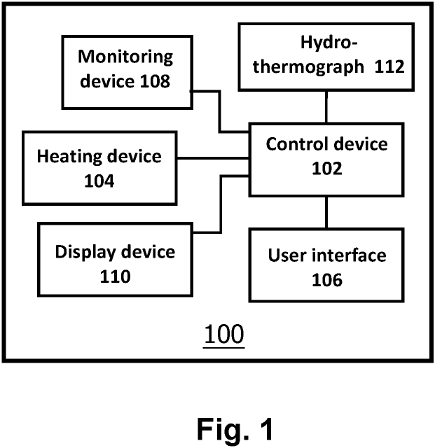

FIG. 1 illustrates a schematic diagram of a drying system or device of tremella according to an embodiment of the present invention. As shown in FIG. 1, the drying system or device 100 of tremella includes a control device 102, a heating device 104, a user interface (or human-machine interface) 106, a monitoring device 108, an image display device 110 and a hydro-thermograph 112. The heating device 104, the user interface 106, the monitoring device108, the image display device 110 and the hydro-thermograph 112 are electrically coupled with the control device 102 to facilitate the implementation of its control and various functions. The control device 102 is a computer control unit, such as a microprocessor and various processors. In one embodiment, the drying system 100 includes a microwave generating device or a baking device. For example, the microwave generating device includes at least one microwave irradiator for emitting microwave to irradiate in an enclosed region. When baking, an appropriate amount of the whole tremella raw material is placed in the enclosed region inside the baking device for irradiation. The whole tremella raw material can be irradiated by the microwave emitted by the microwave irradiator. The monitoring device 108 is arranged in the internal irradiation space of the drying system 100 to monitor the microwave intensity or temperature. The frequency and power of the microwave irradiator of the heating device 104 is adjusted based on the measured value of the monitoring device 108. In addition, the control device 102 is electrically connected with the monitoring device 108 and the microwave irradiator of the heating device 104. The control device 102 provides a control signal to control or adjust the frequency and power of the microwave irradiator based on the monitoring signal provided by the monitoring device 108, so as to realize automatic control.

The heating device 104 is arranged inside the drying system 100 to dry the tremella raw material placed therein. The control device 102 is coupled to the heating device 104 and controls the operation state of the heating device 104 through the user interface 106. The image display device 110 is arranged inside or outside the drying system 100, coupled with the control device 102, so that the user interface 106 offers image displaying, and the image inside the drying system 100 is displayed through the user interface 106 to observe the baking condition of tremella raw materials.

The drying system of tremella shown in FIG. 1 is applied to the drying under atmospheric pressure, while the drying under atmospheric pressure needs a long drying time and a reduced moisture (water) evaporation rate. In the invention, the low-temperature drying technology adopted to completely preserve food nutrition can effectively reduce the nutrient loss in the drying process by using the low-temperature drying method.

In another embodiment, the drying system of tremella includes a vacuum equipment. Before drying, vacuum pumping is performed in the vacuum chamber or enclosed region (food-receiving container), such as using vacuum pump, to discharge the gas in the internal space of the vacuum chamber or container, such as vacuum pumping to reduce the pressure to 0.1 atmospheric pressure. That is, the drying method in the case of using vacuum equipment (under reduced pressure) can improve the internal moisture evaporation rate, and make the cells of tremella with holes such that the internal moisture is easy to diffuse to the surface of tremella.

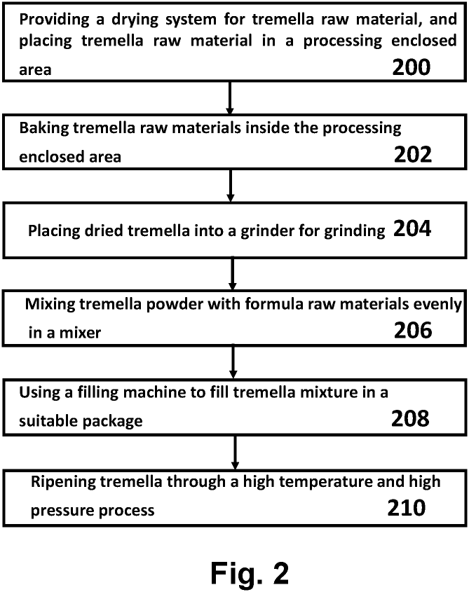

The manufacturing method for filling bag of tremella mixed formula raw materials proposed by the invention includes the following steps, as shown in FIG. 2.

First, the step 200 is executed, providing a drying system for tremella raw material, and the tremella raw material is placed in a processing enclosed area or a food-receiving container.

In the step 200, a drying system or device (for example, using the tremella drying system 100 shown in FIG. 1) is provided for baking the tremella raw material. In some embodiments, the tremella raw material is cleaned, and then the appropriate tremella is selected. The tremella raw material is placed in the processing enclosed area (vacuum chamber or container) and the selected whole tremella is dried. The quantity of these tremella raw materials can be selected and determined as needed.

Next, the step 202 is executed, baking the tremella raw materials inside the processing enclosed area or container.

In the step 202, the heating device 104 is used for baking the tremella raw material to dry the tremella raw material. For example, the electromagnetic wave emitted by a microwave generating device penetrates the inner of the tremella raw material, causing the internal water molecules to be rotated with high speed and vibrated with high frequency, and causing collision between water molecules to increase the internal temperature of the tremella raw material and thereby evaporating water. The frequency, power and microwave irradiating time of the microwave irradiator depend on different conditions or status. In another embodiment, the heating device 104 is replaced by an infrared irradiation device, that is, the tremella raw material inside the drying system 100 is irradiated by infrared. In one embodiment, the microwave power is about 350 watts to 450 watts, and the drying time is about 12 hours to 15 hours. The above parameters are not optional, which are determined based on the material and quantity of the tremella to fully and fastest take the moisture out of the tremella.

The drying method under normal pressure (e.g. atmospheric pressure) needs a long time to dry. The drying conditions of the tremella raw material of the invention include: (1) preheating a food-receiving container of the drying system 100 to internal temperature of 40° C. ~ 45° C., and placing the tremella raw material into the food-receiving container of the drying system 100; (2) the initial temperature is about 35° C., when the water content of the tremella raw material drops to a specific range (e.g. about 30 ~ 40%), the internal temperature of the food-receiving container will gradually rise to 60° C. ~ 70° C. by heating (when the temperature is higher than 70° C., tremella will mature and turn yellow), and the baking time is about 12 ~ 15 hours. The hydro-thermograph 112 is used to regularly measure the water content of the tremella raw material. When the tremella raw material is close to drying, the temperature is reduced to 40° C. ~ 50° C. until drying, which the final water content of the tremella is less than 8%, and the drying process is stopped. As the water content of the tremella is higher than 8%, it will be easy to moisten.

Then, the step 204 is performed, placing the dried tremella into a grinder for grinding.

In the step 204, a grinder (pulverizer) is used to grind the dried tremella to form tremella powder. The dried tremella is taken out from the drying system 100 and then places into the grinder. Meanwhile, the operating ambient temperature is controlled to be less than 20° C. and the humidity to be less than 60% by a controller, and the particle size (tremella powder) after grinding to be less than 250 µ m (microns), about 60 mesh, and the water content of the tremella powder after grinding is still less than 8%. As the dried tremella powder has 40-50 mesh after grinding, it may be too large to be filled in a filling machine, and the leavening process of the tremella powder in contact with water will lead to blocking the pipeline of the filling machine. As the tremella powder is less than 60 mesh, the taste (mouthfeel) of tremella cannot be restored. In addition, as the tremella powder is smaller than 60 mesh, which will make it too small to see and feel in the water.

Subsequently, the step 206 is performed by mixing the tremella powder with formula raw materials evenly in a mixer to start the leavening process.

In the step 206, the tremella powder is added into the other formula raw materials by a mixer (device), so that the tremella powder and the formula raw materials are evenly mixed in a solution to start the leavening process of tremella. The mixer (device) can be used to automatically or manually mix the tremella powder and the formula raw materials in a liquid to form a tremella mixture. The pH value of the acidity of the tremella mixture during the process of leavening is maintained about 4. As it is too acidic (pH value less than 4 or less and less than 4), it will make the tremella unable to leaven and unable to reach the set taste. For example, the other formula raw materials are select at least one or a combination of the following: lotus seeds, black fungus, red beans, mung beans, soybeans, black beans, cereals, job’s tears, traditional Chinese medicine, red jujubes, medlars and cordyceps spp. In addition, the formula raw materials can also choose white gourd (Chinese preserving melon), towel gourd, mint, bamboo shoots, lily, yam, white radish, carrot, fig, grapefruit peel and willow leaves. The species and weight percentage of each formula raw material and tremella can be determined according to the actual application.

For example, the mixer (device) is an automatic mixer, including a bearing container, an outer housing, a motor, a mixing unit, a detection feedback circuit, an operation control unit and a driving unit. The bearing container can carry the tremella powder and formula raw materials to form the tremella mixture. The mixing parameters include the composition of formula raw materials, the proportion of formula raw materials, concentration setting, mixing time and mixing speed.

Next, the step 208 is performed, using a filling machine to fill the tremella mixture in a suitable package.

In the step 208, the tremella mixture (mixed liquid) is quantitatively filled into a filling pipeline of the filling machine to fill and make a small package product of tremella mixed with formula raw materials. In one embodiment, the automatic filling machine comprises a plurality of filling pipelines to correspond to a plurality of packages (packaging bags) respectively. A plurality of packages distributed for the filling machine are sent to the corresponding positions of each filling pipeline of the filling machine to receive the fillings of the tremella mixture, and packaged and sealed by the filling machine.

Finally, the step 210 is executed, ripening the tremella through a high temperature and high pressure process.

In the step 210, after filling, packaging and sealing by the filling machine, a high-temperature and high-pressure process is used to ripen the tremella at this stage and make it leaven again. Accordingly, a large number of trace elements such as tremella polysaccharide, minerals and calcium ions hidden in the deep layer are released from the thick cell wall to fuse a unique ionic flavor. If not processed by this way, it will lose the taste of natural food of tremella itself. This shows the unique feature of the invention and is far better than the traditional tremella products, and therefore the invention has an unexpected effect.

In summary, the features and advantages of the present invention include:

(1) The tremella filling package provided by the invention is different from the common tremella gel that needs to be cooked or bottled.

(2) Most of the lightweight aluminum foil bags only add the boiled tremella soup therein, so the user can not eat tremella itself. The tremella beverage in the aluminum foil bag provided by the invention takes the dried tremella as the base and the principle of low-temperature drying is used to remove water only. Therefore, it can better preserve the taste and nutrition of tremella.

(3) The invention grinds the tremella with particle size that can be filled through the tube. Based on the characteristic that the dried tremella will return fresh tremella when it meets with water, it does not need the cooking and refining process by cauldron for common tremella (which not only can not eat tremella, but also has the problems of preservation and transportation). The invention is suitable for making lightweight aluminum foil carrying package for replenishing the nutrition of tremella at any time.

(4) The tremella packing bag provided by the invention has been studied by the research and development (R & D) team for many years, which overcomes the problem of nutrient loss of tremella after cooking. The invention did maintain the thick polysaccharide released after drying, and can maintain the taste of tremella after the tremella products are produced.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A method for manufacturing filling bag product of tremella, comprising:
preheating a food-receiving container of a drying system to internal temperature of 40° C. ~ 45° C. by a heating device, and placing tremella raw material into said food-receiving container;
heating said food-receiving container to said internal temperature of temperature 60° C. ~ 70° C. to dry said tremella raw material by said heating device when a water content of said tremella raw material drops to a range measured by a hydro-thermograph;
grinding said dried tremella raw material by a grinder to form tremella powder;
mixing said tremella powder with formula raw materials by a mixer to form a tremella mixture; and
filling said tremella mixture in a package by a filling machine.

2. The method of claim 1, wherein particle size of said tremella powder is less than 250 microns.

3. The method of claim 1, wherein a water content of said tremella raw material is less than 8% measured by said hydro-thermograph.

4. The method of claim 1, wherein said heating device is a microwave generator.

5. The method of claim 4, wherein a treatment mode of said microwave generator includes an intermittent heating treatment.

6. The method of claim 4, wherein a treatment mode of said microwave generator includes a continuous heating treatment.

7. The method of claim 1, wherein said heating device is a baking oven.

8. A method for manufacturing filling bag product of tremella, comprising:
preheating a food-receiving container of a drying system to internal temperature of 40° C. ~ 45° C. by a heating device, and placing tremella raw material into said food-receiving container;
heating said food-receiving container to said internal temperature of temperature 60° C. ~ 70° C. to dry said tremella raw material by said heating device when a water content of said tremella raw material drops to a range measured by a hydro-thermograph;
grinding said dried tremella raw material by a grinder to form tremella powder;
mixing said tremella powder with formula raw materials by a mixer to form a tremella mixture;
filling said tremella mixture in a package by a filling machine; and
ripening said tremella mixture in said package through a high temperature and high pressure process.

9. The method of claim 8, wherein particle size of said tremella powder is less than 250 microns.

10. The method of claim 8, wherein a water content of said tremella raw material is less than 8% measured by said hydro-thermograph.

11. The method of claim 8, wherein said heating device is a microwave generator.

12. The method of claim 11, wherein a treatment mode of said microwave generator includes an intermittent heating treatment.

13. The method of claim 11, wherein a treatment mode of said microwave generator includes a continuous heating treatment.

14. The method of claim 8, wherein said heating device is a baking oven.

15. A method for manufacturing filling bag product of tremella, comprising:
preheating a food-receiving container of a drying system to internal temperature of 40° C. ~ 45° C. by a heating device, and placing tremella raw material into said food-receiving container;
heating said food-receiving container to said internal temperature of temperature 60° C. ~ 70° C. to dry said tremella raw material by said heating device when a water content of said tremella raw material drops to a range measured by a hydro-thermograph;
grinding said dried tremella raw material by a grinder to form tremella powder, wherein an operating temperature is less than 20° C. and a humidity is less than 60% controlled by a controller;
mixing said tremella powder with formula raw materials by a mixer to form a tremella mixture;
filling said tremella mixture in a package by a filling machine; and
ripening said tremella mixture in said package through a high temperature and high pressure process.

16. The method of claim 15, wherein particle size of said tremella powder is less than 250 microns.

17. The method of claim 15, wherein a water content of said tremella raw material is less than 8% measured by said hydro-thermograph.

18. The method of claim 15, wherein said heating device is a microwave generator.

19. The method of claim 18, wherein a treatment mode of said microwave generator includes an intermittent heating treatment or a continuous heating treatment.

20. The method of claim 15, wherein said heating device is a baking oven.
